(19) United States
(12) Patent Application Publication
(10) Pub. No.: US 2004/0200701 A1
(43) Pub. Date: Oct. 14, 2004

(54) Electronic apparatus having push buttons on the housing

(75) Inventors: Masato Nakatani, Urawa-shi (JP); Yuji Nakajima, Hamura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/784,894

(22) Filed: Feb. 24, 2004

(30) Foreign Application Priority Data
Feb. 25, 2003 (JP) 2003-047727

(51) Int. Cl. H01H 57/00

(52) U.S. Cl. 200/181

(57) ABSTRACT

An electronic apparatus comprising a housing that has an outer wall. A push button is secured to the outer wall by an arm that can be elastically deformable to move. The push button is positioned, overlapping the arm.

### CROSS-REFERENCE TO RELATED APPLICATIONS

This application is based upon and claims the benefit of priority from the prior Japanese Patent Application No. 2003-047727, filed Feb. 25, 2003, the entire contents of which are incorporated herein by reference.

### BACKGROUND OF THE INVENTION

1. Field of the Invention

The present invention relates to an electronic apparatus that have push buttons such as a click switch button and a power switch button. More particularly, the invention relates to a structure that supports push buttons on the housing of an electronic apparatus.

2. Description of the Related Art

Most portable computers have push buttons such as a power switch button and a click switch button. The push buttons are exposed on the housing of the portable computer. The user of the portable computer can therefore operate the push buttons with the fingers.

Jpn. UM Appln. KOKAI Publication No. 5-87764, Jpn. Pat. Appln. KOKAI publication No. 2001-236852 and U.S. Pat. No. 6,160,232 disclose push buttons that are used on an electronic apparatus such as a portable computer. Each of these push buttons comprises a button body and a plurality of arms. The button body and the arms are made of synthetic resin and formed integral with one another. The button body protrudes outwards through an opening made in an outer wall of the housing of the electronic apparatus. It is therefore exposed outside the housing and can be pushed with a finger. The arms are elastic and project from the periphery of the button body. The arms have their distal ends secured to the inner surface of the outer wall. Thus, the arms support the button body to the housing. Thanks to the elasticity of the arms, the bottom body can be displaced with respect to the housing.

In the case of the conventional push button, the arms that support the button body to the housing of the electronic apparatus project from the periphery of the button body for a long distance. The push button is inevitably large as a whole.

Particularly, the push button disclosed in Jpn. Pat. Appln. KOKAI publication No. 2001-236852 is large because it has a frame that surrounds the button body. The arms are provided between the frame and the button body and connect the button body to the frame. Consequently, the push button cannot be as compact as is desired for a component to be incorporated into the housing of an electronic apparatus.

### BRIEF SUMMARY OF THE INVENTION

According to an embodiment of the present invention, there is provided an electronic apparatus comprises a housing having an outer wall and a push button secured to the outer wall by an arm and overlapping the arm. The arm can be deformed to being elastically deformable to move.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a portable computer according to a first embodiment of this invention;

FIG. 2 is an exploded view illustrating the positional relation between a frame and a printed circuit board, the frame having a click switch button and the board having a click switch and a touch pad;

FIG. 3 is a perspective view of the frame used in the first embodiment of the invention;

FIG. 4 is an exploded view of a push button used in the first embodiment, representing the positional relation between the base and button top of the push button;

FIG. 5 is a rear view of the frame used in the first embodiment of the invention;

FIG. 6 is a magnified view of part F6 of FIG. 5;

FIG. 7 is a rear view of the frame used in the first embodiment, showing first and second click switch buttons attached to the frame;

FIG. 8 is a sectional view of a housing of a second embodiment of the invention, the housing having a push button; and

FIG. 9 is a partly sectional plan view showing the housing of the second embodiment, representing the positional relation between the recess, arms, base and button top.

### DETAILED DESCRIPTION OF THE INVENTION

The first embodiment of the present invention will be described with reference to the accompanying drawings.

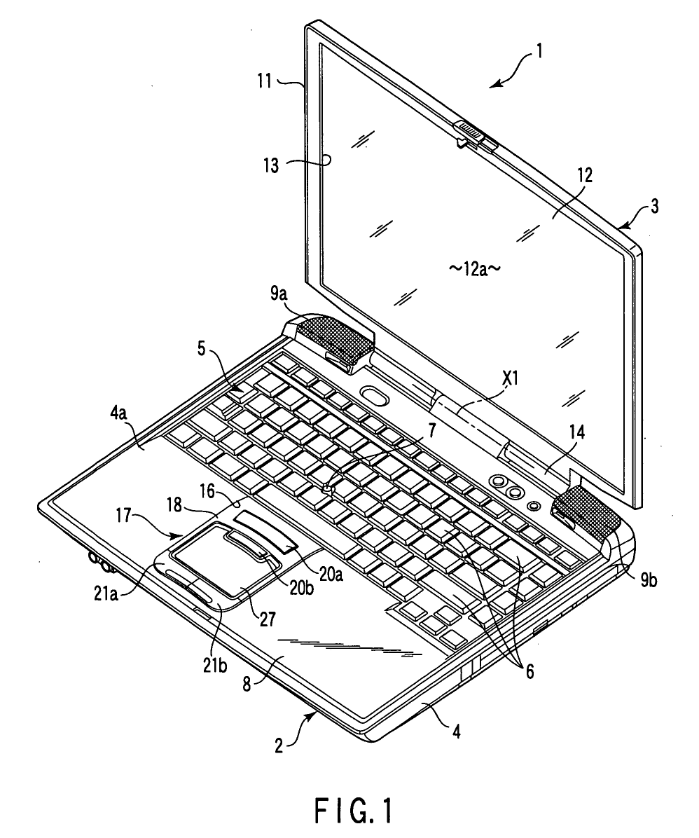

FIG. 1 depicts a portable computer 1, which is an electronic apparatus according to this invention. The portable computer 1 comprises a main unit 2 and a display unit 3.

The main unit 2 has a housing 4 shaped like a flat box. The housing 4 has a top wall 4a that is an outer wall. The top wall 4a supports a keyboard 5. The keyboard 5 has a plurality of key tops 6 and a joystick 7. The joystick 7, which is a pointing device, is positioned at the center of the keyboard 5.

The front half of the top wall 4a serves as a palm rest 8, on which the user of the computer 1 may rest his or her hands. The palm rest 8 is located in front of the keyboard 5. It extends in the widthwise direction of the housing 4. Two speaker units 9a and 9b are secured to the edge of the top wall 4a. They are spaced apart in the widthwise direction of the housing 4 and project upwards from the rear edge of the top wall 4a.

The display unit 3 comprises a display housing 11 and a liquid crystal display panel 12. The display housing 11 is shaped like a flat box and has a rectangular opening 13 in its front. The liquid crystal panel 12 has a screen 12 designed to display images. The screen 12a is exposed outside the display housing 11 through the opening 13.

As FIG. 1 shows, the display housing 11 has a leg 14 at the lower side. The leg 14 lies between the speaker units 9a and 9b. The leg 14 is coupled to the rear edge of the housing 4 by a hinge (not shown). The hinge has an axis X1 that extends in the widthwise direction of the housing 4.

The display unit 3 can rotate around the axis X1 of the hinge, from a closed position and an opened position. At the closed position, the display unit 3 lies on the main unit 2, covering the keyboard 5 and palm rest 8 from above. At the opened position, the display unit 3 stands up, exposing the keyboard 5 and palm rest 8. The screen 12a remains exposed as long as the display unit 3 stays at the opened position.

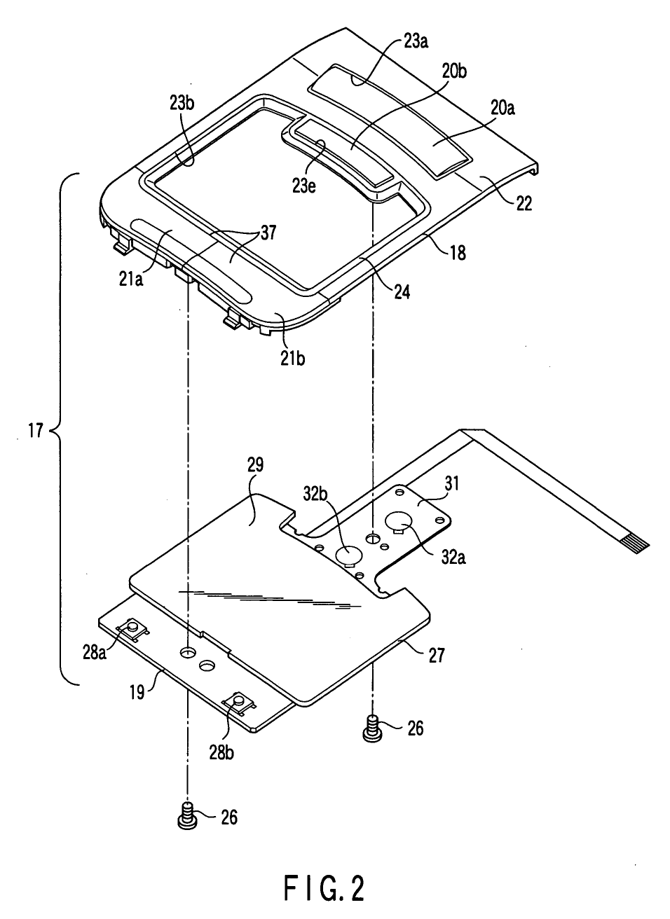

The palm rest 8 has a rectangular hole 16 at a part that is middle with respect to its widthwise direction. A push-button unit 17 is fitted in the hole 16. As FIG. 2 shows, the push-button unit 17 comprises a frame 18, a printed circuit board 19, a first pair of click-switch buttons 20a and 20b, and a second pair of click-switch buttons 21a and 21b.

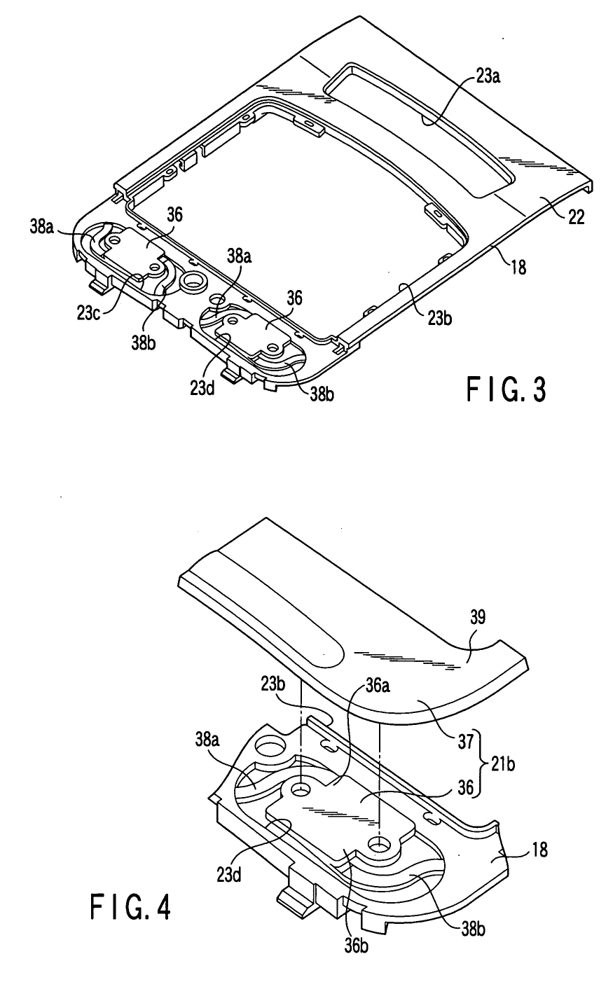

The frame 18 is fitted in the hole 16 made in the palm rest 8. As FIG. 3 illustrates, the frame 18 has a flat upper surface 22 and first to fourth through holes 23a to 23d that open at the upper surface 22. The upper surface 22 of the frame 18 lies in flush with the upper surface of the palm rest 8. The first through hole 23a is a long rectangular one, extending in the widthwise direction of the housing 4. It is made in the rear part of the frame 18, which is adjacent to the keyboard 5. The second through hole 23b is rectangular and made in the center part of the frame 18. A rim 24 is fitted in the second through hole 23b, contacting the edges of the hole 23b. The fifth through hole 23e is made in the rear part of the rim 24. It is a long rectangular one, extending in the widthwise direction of the housing 4 and lies in front of the first through hole 23a. The third and fourth through holes 23c and 23d are elongated in the widthwise direction of the housing 4. They are spaced apart in the widthwise direction of the housing 4.

The printed circuit board 19 is fastened to the lower surface of the frame 18 by means of screws 26. On the upper surface of the printed circuit board 19, a touch pad 27 and a pair of click switches 28a and 28b are mounted. The touch pad 27 is a type of a pointing device. It has an input surface 29, which is flat and which the user of the computer 1 may touch with a finger. The input surface 29 is exposed outside the housing 4, through the second through hole 23b. The click switches 28a and 28b are provided in front of the touch pad 27 and spaced apart in the widthwise direction of the housing 4. They are located right below the third and fourth through holes 23c and 23d, respectively. When depressed, the click switch 28a executes any command input by operating the touch pad 27. When depressed, the click switch 28b cancels any command input by operating the touch pad 27.

A flexible printed wiring board 31 is electrically connected to the rear edge of the printed circuit board 19. The printed wiring board 31 has two click switches 32a and 32b. When depressed, the click switch 32a executes any command input by operating the joystick 7. When depressed, the click switch 32b cancels any command input by operating the joystick 7. The click switches 32a and 32b are provided in rear of the touch pad 27 and spaced apart in the depth direction of the housing 4. They are located right below the first and fifth through holes 23a and 23e, respectively.

As FIG. 2 shows, the click-switch buttons 20a and 20b of the first pair are elongated ones; they are shaped like the first through hole 23a and the fifth through hole 23e. The click-switch buttons 20a and 20b are fitted in the first through hole 23a and fifth through hole 23e from below, respectively. They have their upper surfaces exposed at the upper surface 22 of the frame 18 and can therefore be pushed with fingertips.

As shown in FIG. 7, the click-switch buttons 20a and 20b of the first pair are connected to each other by a pair of arms 33a and 33b. The click-switch buttons 20a and 20b and the arms 33a and 33b are made of synthetic resin and formed integral. The arms 33a and 33b are elastic. The arms 33a and 33b extend between the click-switch buttons 20a and 20b, each curved around one end of the click-switch button 20a. The arms 33a and 33b have their middle parts fastened to the frame 18 with two screws 34, respectively.

Thus, the click-switch buttons 20a and 20b of the first pair are supported on the frame 18 by the arms 33a and 33b. Since the arms 33a and 33 are elastic, the click-switch buttons 20a and 20b can be moved between a standby position and a depressed position. At the standby position, the click-switch buttons 20a and 20b protrude a little from the upper surface 22 of the frame 18. At the depressed position, the click-switch buttons 20a and 20b lie a little below the standby position.

The click-switch buttons 20a and 20a of the first pair have a projection 35 each. The distal ends of the projections 35 of the click-switch buttons 20a and 20b face the click switches 32a and 32b, respectively. When the user pushes the click-switch button 20a or 20b with a fingertip, from the standby position to the depressed position, the projection 35 contacts the click switch 32a or 32b. That is, the click switch 32a or 32b is turned on.

The click-switch buttons 21a and 21b of the second pair are push buttons according to the present invention. The click-switch buttons 21a and 21b comprise a base 36 and a button top 37 each. The bases 36 of the click-switch buttons 21a and 21b are provided in the third and fourth through holes 23c and 23d, respectively.

To be more specific, the bases 36 are plates that are smaller than the third and fourth through holes 23c and 23d. They are surrounded by the rims of the holes 23c and 23d, respectively. Each base 36 have a first end part 36a and a second end part 36b, which are spaced apart in the lengthwise direction of the through hole 23c or 23d. The end parts 36a and 36b of one base 36 are connected to the rim of the third through holes 23c by two arms 38a and 38b. The end parts 36a and 36b of the other base 36 are connected to the rim of the fourth through hole 23d of the frame 18 by two arms 38a and 38b. The frame 18, bases 36 and arms 38a and 38b are made of synthetic resin and formed integral with one another. The arms 38a and 38b are elastic.

The arms 38a and 38b project from the frame 18 inwards in the third and fourth through holes 23c and 23d, respectively. In other words, the arms 38a and 38b are symmetrically held between the rim of the third and fourth through hole 23c and 23d and the base 36 of the click-switch buttons 21a and 21b.

The button tops 37 of the click-switch buttons 21a and 21b are made of synthetic resin. They are shaped like a flat plate and larger than the bases 36. Each button top 37 is secured to the base 36 by means of heat bonding or adhesion and covers the base 36 from above. Thus, the click-switch buttons 21a and 21b of the second pair are supported on the frame 18 by the arms 38a and 38b. They can be moved between a standby position and a depressed position, thanks to the elasticity of the arms 38a and 28b.

At the standby position, the click-switch buttons 21a and 21b have their upper surfaces set in flush with the upper surface 22 of the frame 18. At the depressed position, the click-switch buttons 21a and 21b lie below the standby position. Since the arms 38a and 38b are symmetrically arranged, either click-switch button of the second pair can be moved down without inclining to the frame 18.

As FIG. 4 illustrates, the peripheral part 39 of either button top 37 protrudes from the periphery of the base 36. It covers the third and fourth through holes 23c and 23d and the arms 38a and 38b, from above the frame 18. That is, the button top 37 of either click-switch button of the second pair overlaps the arms 38a and 38b. Hence, the arms 38a and 38b lie below the peripheral part 39 of the button top 37.

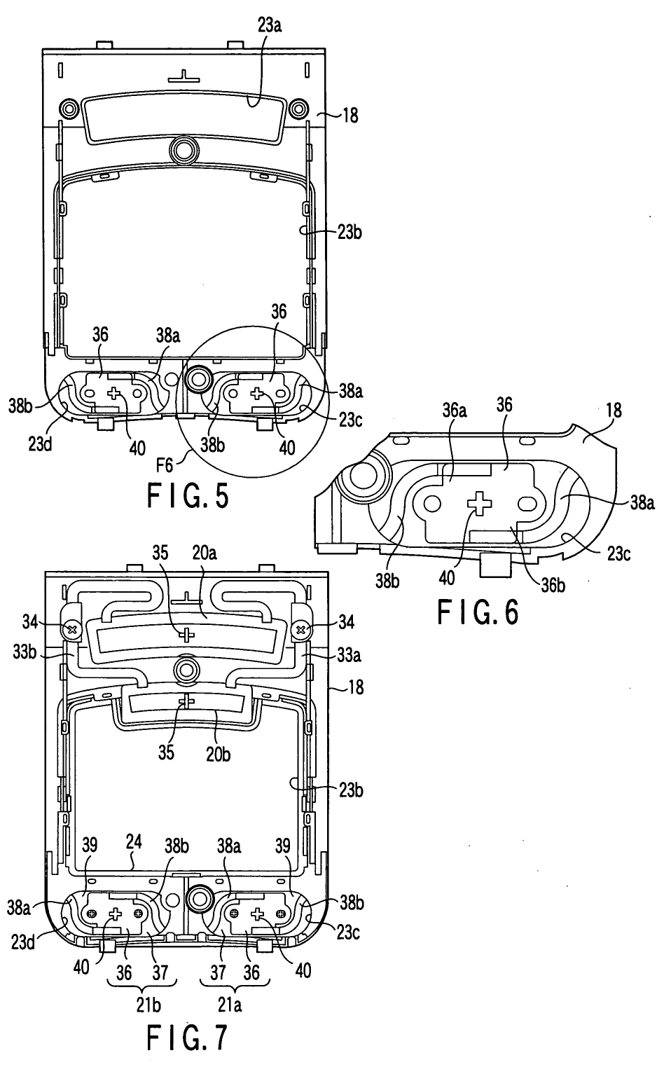

As shown in FIGS. 5 to 7, the bases 36 of the click-switch buttons 21a and 21b of the second pair have a projection 40 each. The projection 40 is provided on the center part of the lower surface of either click-switch button (21a, 21b). The distal ends of the projections 40 opposes the click switches 28a and 28b, respectively. When the user pushes the click-switch button 21a or 21b with fingertip, from the standby position to the depressed position, the projection 40 of the click-switch button contacts the click switch associated with the click-switch button pushed. As a result, the click switch 28a or 28b is turned on.

In this configuration, the arms 38a and 38b that support the click-switch buttons 21a and 21b of the second pair remain overlapping the peripheral parts 39 of the button tops 37, respectively. Thus, the peripheral parts 39 of the button tops 37 covers the arms 38a and 38b, respectively, from above the frame 18.

Neither the arm 38a nor the arm 38b protrude from the button tops 37. The arms 38a and 38b can be placed in the third and fourth through holes 23c and 23d of the frame 18. This helps to reduce the space for the click-switch buttons 21a and 21b of the second pair and ultimately to make the frame 18 small. Therefore, the push-button unit 17 is so compact that it can be provided on the palm rest 8, i.e., the front half of the top wall 4a of the housing 4.

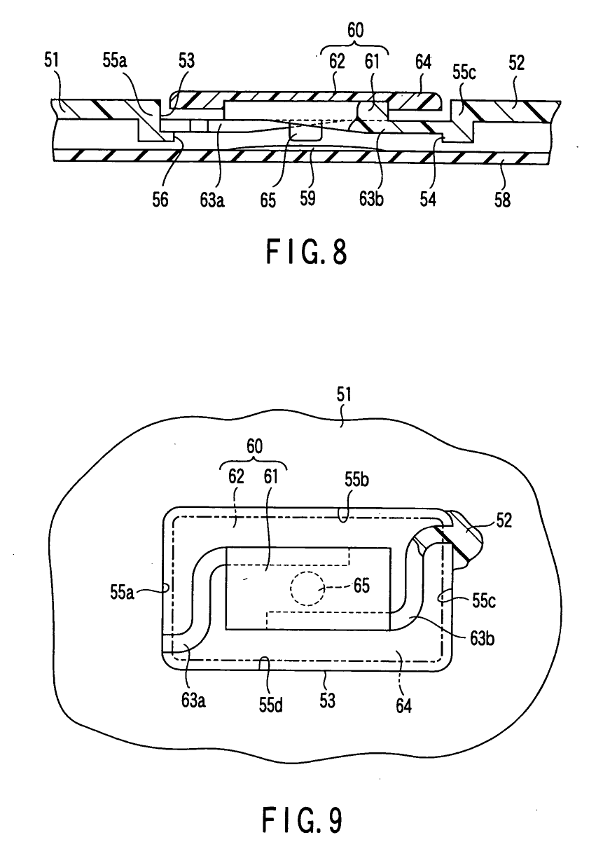

An electronic apparatus according to the second embodiment of the invention will be described, with reference to FIGS. 8 and 9.

As FIGS. 8 and 9 show, the housing 51 of the electronic apparatus has an outer wall 52. The outer wall 52 has a rectangular recess 53. The recess 53, which opens outside the housing 51, provides a button region. The recess 53 is defined by a bottom wall 54 and four side walls 55a to 55d. The bottom wall 54 has an opening 56, which exposes the interior of the housing 51.

The housing 51 contains a printed circuit board 58. The printed circuit board 58 has a push-type switch 59. The switch 59 opposes the opening 56.

A push button 60 is arranged in the recess 53 made in the outer wall 53. When the push button 60 is depressed, it actuates the push-type switch 59. The push button 60 comprises a base 61 and a button top 62. The base 61 lies within the recess 53 and is surrounded by the side walls 55a to 55d. The base 61 has a first end part 61a and a second end part 61b, which are spaced apart in the lengthwise direction of the recess 53. Arms 63a and 63b secure the end parts 61a and 61b to the side walls 55a and 55c, respectively. The outer wall 52, base 61 and the arms 63a and 63b are made of synthetic resin and formed integral with one another. The arms 63a and 63 are elastic.

The arms 63a and 63b are provided in the space defined by the side walls 55a and 55c, on the one hand, and the base 61, on the other hand. The arms 63a and 63b are bent in the form of letter S and exhibit sufficient elasticity. They are symmetrical with respect to the base 61.

The button top 62 is made of synthetic resin. It is shaped like a flat plate and larger than the base 61. It is secured to the base 61 by means of heat-bonding or adhesion and covers the base 61 from above. The push button 60 is therefore held in the recess 53 and supported by the arms 63a and 63b. Thanks to the elasticity of the arms 63a and 63b, the push button 60 can be moved between a standby position and a depressed position.

At the standby position, the push button 60 outwardly projects a little from the outer wall 52. At the depressed position, the push button 60 lies deeper in the recess 53 than at the standby position. While depressed, the push button 60 does not incline to the bottom wall 54, because the arms 63a and 63b lie symmetrical to each other with respect to the base 61.

The peripheral part 64 of the bottom top 62 protrudes from the periphery of the base 61. It covers the bottom wall 54, opening 56 and arms 63a and 63b. In other words, the button top 62 of the push button 60 overlaps the arms 63a and 63b. Hence, the arms 63a and 63b are located between the bottom wall 54 and the peripheral part 64 of the bottom top 62.

As FIG. 8 depicts, the base 61 of the push button 60 has a projection 65. The projection 65 is provided on the center part of the lower surface of the base 61. The distal ends of the projections 65 opposes the push-type switch 59 through the opening 56. When the user pushes the push button 60 with fingertip, from the standby position to the depressed position, the distal end of the projection 65 contacts the switch 59. The switch 59 is thereby turned on.

In the second embodiment, the arms 63a and 63b that support the push button 60 remain overlapping the outer peripheral part 64 of the button top 62. It stays in the space defined by the peripheral part 64 and the bottom wall 54.

Hence, neither the arm 63a nor the arm 63b protrude from the button top 62. The arms 63a and 63b can be placed in the recess 53. This helps to reduce the space for the push button 60.

The present invention is not limited to the embodiments described above. For example, two arms need not be provided to support one push button. Only one arm may support one end of each push button.

Moreover, the electronic apparatus according to the present invention is not limited to a portable computer. This invention can be applied to any other type of an information apparatus, such as a PDA (Personal Digital Assistant).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a housing having an outer wall; and
a push button secured to the outer wall by an arm and overlapping the arm, the arm being elastically deformable to move.

2. The electronic apparatus according to claim 1, wherein the arm and the push button are formed integral with each other.

3. The electronic apparatus according to claim 1, wherein the outer wall and the arm are formed integral with each other.

4. The electronic apparatus according to claim 1, further comprising a frame secured to the outer wall and supporting the arm.

5. The electronic apparatus according to claim 4, wherein the arm and the frame are formed integral with each other.

6. The electronic apparatus according to claim 4, wherein the outer wall has a hole in which the frame is fitted.

7. The electronic apparatus according to claim 4, wherein the push button comprises a base and a button top larger than the base, and the arm extends from the base to the frame and is covered by the button top.

8. The electronic apparatus according to claim 7, wherein the frame surrounds the base and the arm protrudes inside the frame.

9. The electronic apparatus according to claim 1, wherein the housing has a switch which opposes the push button and which is to be actuated when the push button is depressed.

10. An electronic apparatus comprising:
a housing having an outer wall;
a frame secured to the outer wall and having a plurality of arms which is elastically deformable to move; and
a push button held between the arms, overlapping the arms and being able to move with respect to the frame.

11. The electronic apparatus according to claim 10, wherein the push button comprises a base and a button top larger than the base, and the arms couple the base and the frame together and are covered by the button top.

12. The electronic apparatus according to claim 10, wherein the frame, the arms and the base are made of synthetic resin and formed integral with each other, and the arms are arranged symmetrically with respect to the base.

13. The electronic apparatus according to claim 10, wherein the outer wall has a hole in which the frame is fitted.

14. An electronic apparatus comprising:
a housing having a button region;
a push button arranged in the button region; and
an arm which is provided between the push button and the button region, which overlaps the push button and which supports the push button, allowing the push button to move with respect to the button region.

15. The electronic apparatus according to claim 14, wherein the housing, the arm and the push button are formed integral with one another.

16. The electronic apparatus according to claim 14, wherein the button region includes a recess defined by side wall which surround the push button, and the arm protrudes toward the push button from the side wall.

17. The electronic apparatus according to claim 14, wherein the push button comprises a base and a button top larger than the base, and the arm couples the base and the side wall together and is covered by the button top.

18. A push button unit comprising:
a frame;
an arm protruding inside the frame and having an end which elastically deformable to move; and
a push button supported by the arm, being able to move with respect to the frame and overlapping the arm.

19. The push button unit according to claim 18, wherein the frame, the arm and the push button are made of synthetic resin and formed integral with one another.

20. The push button unit according to claim 18, wherein the push button comprises a base and a button top larger than the base, and the arm couples the base and the frame together and is covered by the button top.
